(19) United States
(12) Patent Application Publication
(10) Pub. No.: US 2020/0167568 A1
(43) Pub. Date: May 28, 2020

(54) IMAGE PROCESSING METHOD, DEVICE, AND STORAGE MEDIUM

(71) Applicant: SHANGHAI CLOBOTICS TECHNOLOGY CO., LTD., Shanghai (CN)

(72) Inventors: Xiaojun Hu, Shanghai (CN); Yan Ke, Shanghai (CN); George Christopher Yan, Shanghai (CN)

(21) Appl. No.: 16/691,035

(22) Filed: Nov. 21, 2019

(30) Foreign Application Priority Data
Nov. 23, 2018 (CN) 2018114081430

(51) Int. Cl. G06K 9/00; G06T 11/00; G06T 7/73

(52) U.S. Cl. CPC G06K 9/00671; G06K 9/00718; G06T 2207/10016; G06T 7/74; G06T 11/00

(57) ABSTRACT

Provided are an image processing method device, and a storage medium. The method includes: at an electronic device with a processor, a memory and a camera: acquiring first video data for commodities on a shelf; converting the first video data into a plurality of single-frame images; generating a virtual image scenario according to the plurality of single-frame images; acquiring second video data for the commodities on the shelf; performing unit identification on the plurality of single-frame images in the second video data with a preset unit identification model to identify a plurality of commodity regions; labeling the identified plurality of commodity regions; and replacing corresponding regions in the virtual image scenario with ones of the single-frame images with the labeled commodity regions.

### CROSS-REFERENCE TO RELATED APPLICATIONS

This application claims priority to Chinese Patent Application No. 201811408143.0, filed with the National Intellectual Property Administration, PRC (CNIPA) on Nov. 23, 2018, which is incorporated herein by reference in its entirety.

### FIELD

The present disclosure relates to a new retail, and specifically to an image processing method, device, and a storage medium.

### BACKGROUND

Although on-line retail has replaced the function of traditional retail for a period of time, it can be seen from the costs of customer acquisition of the two e-commerce platforms Tmall and JD that the on-line traffic of e-commerce has gained peak dividends. At the same time, the off-line marginal costs of customer acquisition remain almost unchanged, and the physical retail has entered a critical period of rectification, resulting in the revaluation of values of off-line channels.

New techniques such as mobile payment have opened up the popularity of intelligent terminals in off-line scenarios, and the resulting technological innovations such as mobile payment, big data, and virtual reality have further opened up off-line scenarios and consumption socialization, so that consumption is no longer constrained by time and space.

Nowadays, many enterprises are relying on the Internet to upgrade and transform the production, circulation and sales processes of commodities with the use of advanced technical means such as big data and artificial intelligence, then rebuild a business structure and ecosystem, and perform a new retail mode with deep integration of on-line services, off-line experiences and modern logistics.

In order to improve users' off-line shopping experience and shopping efficiency, in the new retail mode, the commodities in off-line stores need to be identified by mobile terminals. In the prior art, training images used for training an identification model are obtained by acquiring a large number of images, then regions of interest are selected one by one with a box by a user, and commodity categories of the corresponding regions that are selected with boxes are labeled. When the user needs to process too many images, the user needs to select one by one with a box, so the operation is extremely cumbersome, and at the same time, due to frequent selection operations with boxes and insufficient image capturing clarity, the user may be mis-operated, which is time consuming and labor intensive.

### SUMMARY

The present disclosure provides an image processing method, device, and a storage medium.

In an aspect, an method is provided, which includes:

at an electronic device with a processor, a memory and a camera:
acquiring first video data for commodities on a shelf;
converting the first video data into a plurality of single-frame images;
generating a virtual image scenario according to the plurality of single-frame images;
acquiring second video data for the commodities on the shelf;
performing unit identification on the plurality of single-frame images in the second video data with a preset unit identification model to identify a plurality of commodity regions;
labeling the identified plurality of commodity regions; and
replacing corresponding regions in the virtual image scenario with ones of the single-frame images with the labeled commodity regions.

In another aspect, an electronic device is provided, which includes:

a camera;

a processor; and

a memory storing program instructions that, when executed by the processor, cause the electronic device to performing the following operations:
acquiring first video data for commodities on a shelf;
converting the first video data into a plurality of single-frame images;
generating a virtual image scenario according to the plurality of single-frame images;
acquiring second video data for the commodities on the shelf;
performing unit identification on the plurality of single-frame images in the second video data with a preset unit identification model to identify a plurality of commodity regions;
labeling the identified plurality of commodity regions; and
replacing corresponding regions in the virtual image scenario with ones of the single-frame images with the labeled commodity regions.

In still another aspect, a computer readable storage medium is provided, which stores a program that, when executed by a processor of a computing device, cause the computing device to performing the following operations:
acquiring first video data for commodities on a shelf;
converting the first video data into a plurality of single-frame images;
generating a virtual image scenario according to the plurality of single-frame images;
acquiring second video data for the commodities on the shelf;
performing unit identification on the plurality of single-frame images in the second video data with a preset unit identification model to identify a plurality of commodity regions;
labeling the identified plurality of commodity regions; and
replacing corresponding regions in the virtual image scenario with ones of the single-frame images with the labeled commodity regions.

### BRIEF DESCRIPTION OF THE DRAWINGS

Other features, objectives, and advantages of the present disclosure will become more apparent by reading the detailed description of a non-limiting embodiment with reference to the following accompanying drawings:

FIG. 1 is a step flowchart of an augmented reality-based image marking method according to the present disclosure;

FIG. 2 is a step flowchart of generating a position coordinate relationship between a virtual image scenario and a camera according to the present disclosure;

FIG. 3 is a step flowchart of marking a commodity region according to the present disclosure;

FIG. 4 is a step flowchart of triggering unit identification according to the present disclosure;

FIG. 5 is a step flowchart of correcting and marking a target frame image to be marked according to the present disclosure;

FIG. 6 is a step flowchart of updating a virtual image scenario according to the present disclosure;

FIG. 7 is a schematic module diagram of an augmented reality-based image marking method according to the present disclosure;

FIG. 8 is a schematic structural diagram of an augmented reality-based image marking device according to the present disclosure; and

FIG. 9 is a schematic structural diagram of a computer-readable storage medium according to the present disclosure.

### DETAILED DESCRIPTION OF EMBODIMENTS

The present disclosure will be described in detail below in combination with specific embodiment. The following examples are helpful for those skilled in the art to further understand the present disclosure, but are not intended to limit the present disclosure in any way. It should be noted that those of ordinary skill in the art could also make several alterations and improvements without departing from the spirit of the present disclosure. These alterations and improvements shall fall within the scope of the present disclosure.

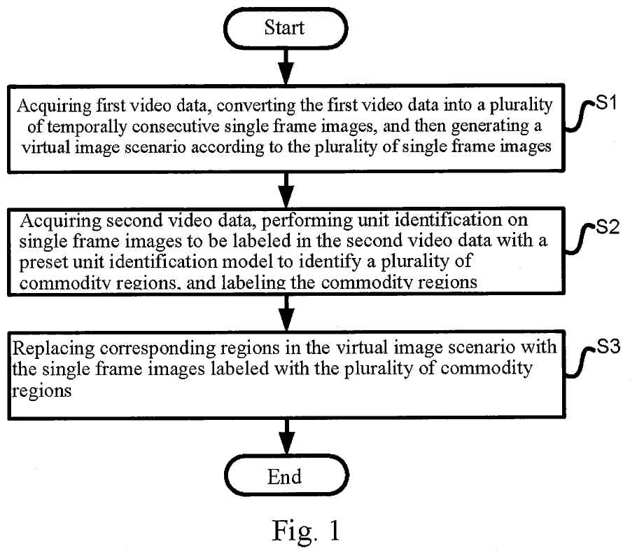

FIG. 1 is a step flowchart of an augmented reality-based image marking method according to the present disclosure. As shown in FIG. 1, the augmented reality-based image marking method provided by the present disclosure is for marking images of commodities on a shelf by using a smart phone, and comprises the following steps:

step S1: acquiring first video data, converting the first video data into a plurality of temporally consecutive single-frame images, and then generating a virtual image scenario according to the plurality of single-frame images;

step S2: acquiring second video data, performing unit identification on the single-frame images to be labeled in the second video data with a preset unit identification model to identify a plurality of commodity regions, and labeling the commodity regions; and step S3: replacing corresponding regions in the virtual image scenario with single-frame images with the labeled plurality of commodity regions.

In embodiments, the unit identification model may be pre-trained by training images labeled with commodity regions, and may also be a trained unit identification model in the prior art.

In embodiments, a virtual image scenario can be established according to the first video data acquired by a camera of the smart phone, and then a commodity region identified by means of unit identification can be supplemented to the virtual image scenario, so that the marking of the commodity region in the virtual image scenario is achieved, thereby preventing repeated marking of the same commodity region, and improving the efficiency of marking the commodity region and generating training images. The present disclosure can be applied to a smart phone, so that commodities can be directly identified and marked in front of a shelf, thereby improving the accuracy of marking, and preventing errors caused by unclear images or high commodity similarity.

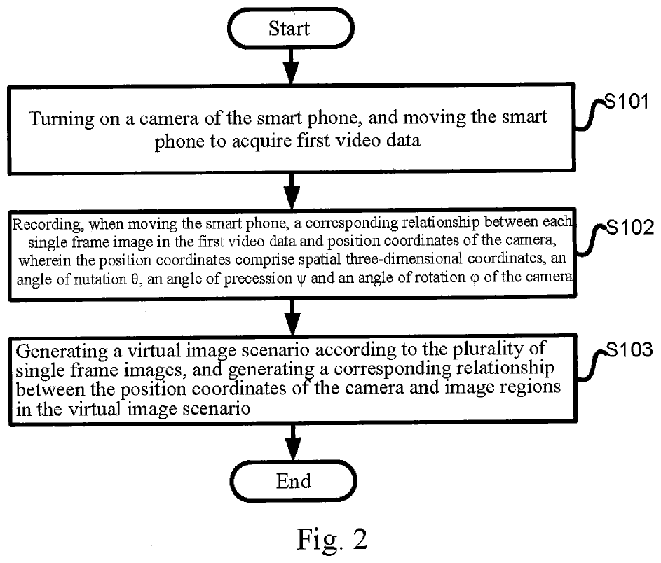

FIG. 2 is a step flowchart of generating a position coordinate relationship between a virtual image scenario and a camera according to the present disclosure. As shown in FIG. 2, step S1 comprises the following steps:

step S101: turning on a camera of the smart phone, and moving the smart phone to acquire first video data;

step S102: recording, when moving the smart phone, a corresponding relationship between each single-frame image in the first video data and position coordinates of the camera, wherein the position coordinates comprise spatial three-dimensional coordinates, an angle of nutation θ, an angle of precession ψ and an angle of rotation φ of the camera; and step S103: generating a virtual image scenario according to the plurality of single-frame images, and generating a corresponding relationship between the position coordinates of the camera and image regions in the virtual image scenario.

That is, in embodiments, the virtual image scenario is generated from a scenario captured by the camera of the smart phone according to the change in the spatial position of the smart phone and the change in the Euler angle of the camera. The spatial three-dimensional coordinates of the camera may be generated by using the GPS information, and may also be generated by directly establishing a three-dimensional spatial coordinate system.

In embodiments, the virtual image scenario is established using the ARkit platform of Apple Inc.

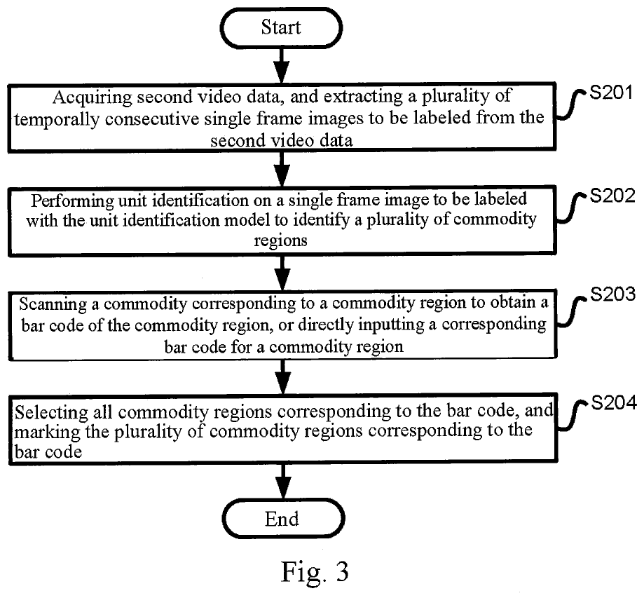

FIG. 3 is a step flowchart of marking a commodity region according to the present disclosure. As shown in FIG. 3, step S2 comprises the following steps:

step S201: acquiring second video data, and extracting a plurality of temporally consecutive single-frame images to be marked from the second video data;

step S202: performing unit identification on the single-frame images to be marked with the unit identification model to identify a plurality of commodity regions and labeling the identified commodity regions with label boxes;

step S203: scanning a commodity corresponding to a commodity region to obtain a bar code of the commodity region, or directly inputting a corresponding bar code for a commodity region;

step S204: selecting all commodity regions corresponding to the bar code, thus completing marking the commodity regions corresponding to the bar code.

In embodiments, the label boxes are rectangular boxes.

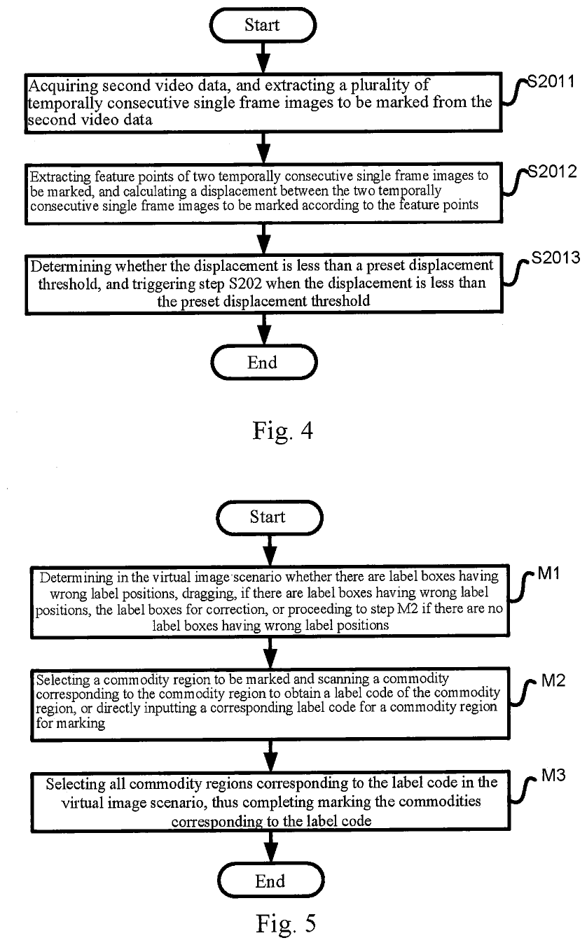

FIG. 4 is a step flowchart of triggering unit identification according to the present disclosure. As shown in FIG. 4, step S201 comprises the following steps:

step S2011: acquiring second video data, and extracting a plurality of temporally consecutive single-frame images to be marked from the second video data;

step S2012: sequentially extracting feature points of two temporally consecutive single-frame images to be marked, and calculating a displacement between the two temporally consecutive single-frame images to be marked according to the feature points; and

step S2013: determining whether the displacement is less than a preset displacement threshold, and triggering step S202 when the displacement is less than the preset displacement threshold.

In embodiments, the preset displacement threshold may be set to 1 cm. That is, the unit identification of the commodity regions is performed only when the smart phone is determined to be relatively static.

In embodiments, a single-frame image to be marked is selected as a target frame image to be marked from two temporally consecutive single-frame images to be marked when the displacement is less than a preset displacement threshold; and unit identification is performed on the target frame image to be marked with the unit identification model to identify a plurality of commodity regions, and each commodity region is labeled with a label box.

FIG. 5 is a step flowchart of correcting and marking a target frame image to be marked according to the present disclosure. As shown in FIG. 5, the following steps are further comprised after step S3:

step M1: determining in the virtual image scenario whether there are label boxes having wrong label positions, dragging, if there are label boxes having wrong label positions, the label boxes for correction, or proceeding to step M2 if there are no label boxes having wrong label positions;

step M2: selecting a commodity region to be marked and scanning a commodity corresponding to the commodity region to obtain a label code of the commodity region, or directly inputting a corresponding label code for a commodity region for marking;

step M3: selecting all commodity regions corresponding to the label code in the virtual image scenario, thus completing marking the commodities corresponding to the label code.

In embodiments, the commodity regions may be acquired before step M2 and then marked to generate training images, or the marked commodity regions may also be acquired after the marking is completed in step M3, to directly generate training images.

In embodiments, the unit identification model is based on the Create ML model of Apple Inc, and the acquired training images may also be used to train the Create ML model.

In embodiments, it may be directly determined by an operator whether there are label boxes having wrong label positions, and scanning to obtain a label code may also be performed by an operator.

In embodiments, the label code may be a bar code.

In embodiments, the label boxes having wrong label positions comprise any one or more of the following errors:
part of a commodity region is outside the label box;
part of two adjacent commodity regions are inside the label box; and
the ratio of the area of the label box to the area of the commodity region is greater than a preset ratio threshold.

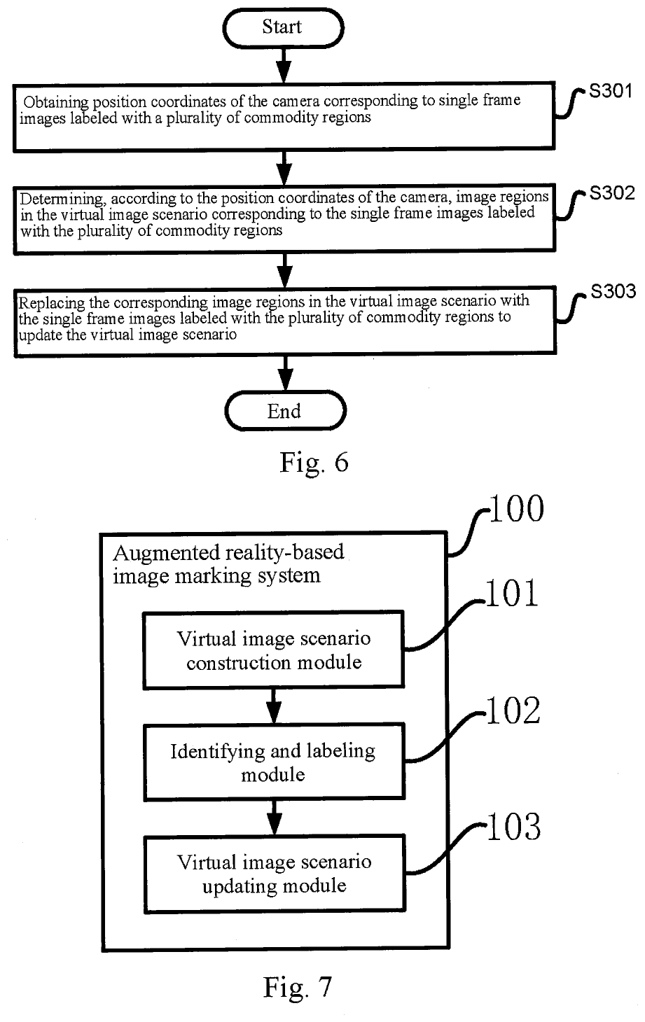

FIG. 6 is a step flowchart of updating a virtual image scenario according to the present disclosure. As shown in FIG. 6, step S3 comprises the following steps:

step S301: obtaining position coordinates of the camera corresponding to the single-frame images labeled with a plurality of commodity regions;

step S302: determining, according to the position coordinates of the camera, image regions in the virtual image scenario corresponding to the single-frame images labeled with the plurality of commodity regions; and

step S303: replacing the corresponding image regions in the virtual image scenario with the single-frame images labeled with the plurality of commodity regions to update the virtual image scenario.

In embodiments, the single-frame images labeled with commodity regions are all mapped into the virtual image scenario, and then labeling is performed in the virtual image scenario.

In a variant example, the single-frame images labeled with a plurality of commodity regions may also be stitched into the corresponding image regions in the virtual image scenario by means of a feature point matching method.

When the augmented reality-based image marking method provided by the present disclosure is used, the software that performs the augmented reality-based image marking method according to the present disclosure may be installed on a smart phone. When the software is run, the camera of the smart phone is automatically turned on to acquire first video data, the smart phone is moved to acquire video data of the whole shelf, and the virtual image scenario can be established based on the first video data. Then, the smart phone is kept relatively static to aim at a region on the shelf to implement unit identification on the region for commodity region, and the labeled commodity region is integrated into the virtual image scenario. Further, label boxes having label errors are dragged in the virtual image scenario to ensure that each label box encloses a commodity region, then the enclosed commodity regions are acquired; finally, a commodity region is selected, a corresponding commodity is taken out from the shelf, the bar code of the commodity is scanned to implement marking of the commodity region, and all corresponding commodity regions of the commodity in the virtual image scenario are selected and can thus be marked.

FIG. 7 is a schematic module diagram of an augmented reality-based image marking method according to the present disclosure. As shown in FIG. 7, an augmented reality-based image marking system 100 provided by the present disclosure is for implementing the augmented reality-based image marking method, and comprises:

a virtual image scenario construction module 101, configured to acquire first video data, convert the first video data into a plurality of temporally consecutive single-frame images, and then generate a virtual image scenario according to the plurality of single-frame images;

an identifying and labeling module 102, configured to acquire second video data, perform unit identification on the single-frame images to be labeled in the second video data with a preset unit identification model to identify a plurality of commodity regions, and label the commodity regions; and

a virtual image scenario updating module 103, configured to replace corresponding regions in the virtual image scenario with single-frame images labeled with the plurality of commodity regions.

An embodiment of the present disclosure also provides an augmented reality-based image marking device, comprising a processor; and a memory storing executable instructions of the processor, wherein the processor is configured to perform the steps of the augmented reality-based image marking method by performing the executable instructions.

It could be appreciated by those skilled in the art that various aspects of the present disclosure may be implemented as systems, methods, or program products. Therefore, the various aspects of the present disclosure may be implemented in the following forms: complete hardware implementations, complete software implementations (including firmware, microcodes, etc.), or combined implementations of hardware and software, which may be collectively referred to as “circuits”, “modules”, or “platforms” herein.

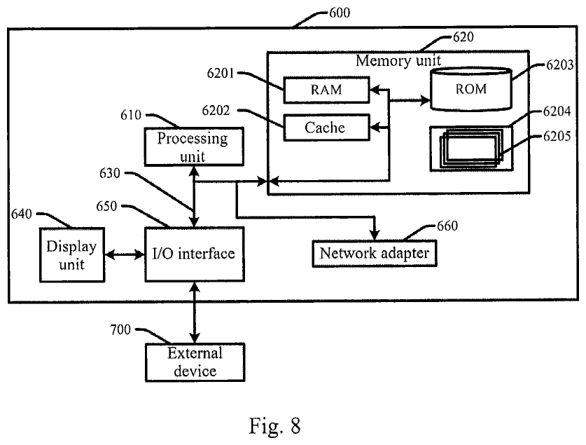

FIG. 8 is a schematic structural diagram of an augmented reality-based image labeling device according to the present disclosure. An electronic device 600 according to the implementation of the present disclosure will be described below with reference to FIG. 8. The electronic device 600 shown in FIG. 8 is just an example, which does not impose any restrictions on the functions and scope of application of the embodiment of the present disclosure.

As shown in FIG. 8, the electronic device 600 is embodied in the form of a general-purpose computing device. The components of the electronic device 600 may comprise, but are not limited to, at least one processing unit 610, at least one memory unit 620, a bus 630 that connects different platform components (including the memory unit 620 and the processing unit 610), a display unit 640, and the like.

The memory unit stores program codes, and the program codes may be executed by the processing unit 610, so that the processing unit 610 performs the steps according to various exemplary implementations of the present disclosure described in the augmented reality-based image marking method section of the specification. For example, the processing unit 610 may perform the steps as shown in FIG. 1.

The memory unit 620 may comprise a readable medium in the form of a volatile memory unit, such as a random access memory (RAM) 6201 and/or a cache 6202, and may further comprise a read-only memory (ROM) 6203.

The memory unit 620 may also comprise a program/utility tool 6204 having a set (at least one) of program modules 6205, such program module 6205 comprising, but not limited to an operating system, one or more applications, other program modules, and program data. Each one or a combination of these examples may comprise the implementation of a network environment.

The bus 630 may represent one or more of several types of bus structures, comprising a memory unit bus or memory unit controller, a peripheral bus, a graphics acceleration port, a processing unit, or a local area bus using any of a variety of bus structures.

The electronic device 600 may also communicate with one or more external devices 700 (e.g., a keyboard, a pointing device, a Bluetooth device, etc.), and may also communicate with one or more devices that enable a user to interact with the electronic device 600, and/or communicate with any device (e.g., a router, a modem, etc.) that enables the electronic device 600 to communicate with one or more other computing devices. The communication may be performed via an input/output (I/O) interface 650. In addition, the electronic device 600 may also communicate with one or more networks (e.g., a local area network (LAN), a wide area network (WAN), and/or a public network, such as the Internet) via a network adapter 660. The network adapter 660 may communicate with other modules of the electronic device 600 through the bus 630. It should be understood that although not shown in FIG. 8, other hardware and/or software modules may be used in combination with the electronic device 600, comprising but not limited to: microcodes, a device driver, a redundant processing unit, an external disk drive array, an RAID system, a tape driver, a data backup storage platform, etc.

An embodiment of the present disclosure further provides a computer-readable storage medium for storing a program, wherein the steps of the augmented reality-based image marking method are implemented when the program is executed. In some possible implementations, various aspects of the present disclosure may also be implemented in the form of a program product comprising program codes, wherein when the program product is run on a terminal device, the program codes are used to enable the terminal device to perform the steps according to various exemplary implementations of the present disclosure described in the augmented reality-based image marking method section of the specification.

As descried above, when the program of the computer-readable storage medium of the present embodiment is executed, by means of the present disclosure, a plurality of fan blade images corresponding to a fan blade can be sequentially spliced in an order of acquisition time to form a complete fan blade image, which facilitates accurate positioning of defects on the fan blade, and facilitates positioning of the defects during maintenance of the fan blade.

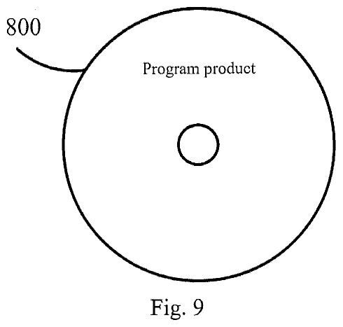

FIG. 9 is a schematic structural diagram of a computer-readable storage medium according to the present disclosure. Referring to FIG. 9, a program product 800 according to an implementation of the present disclosure for implementing the above method is described. The program product may be a portable compact disk read-only memory (CD-ROM), and comprises program codes, and may be run on a terminal device, for example, a personal computer. However, the program product of the present disclosure is not limited thereto. The readable storage medium herein may be any tangible medium containing or storing a program which may be used by or in combination with an instruction execution system, apparatus or device.

The program product may be a readable medium or any combination of more readable media. The readable medium may be a readable signal medium or a readable storage medium. An example of the readable storage medium may be, but is not limited to electric, magnetic, optical, electromagnetic, infrared, or semiconductor systems, apparatuses or devices, or any combination of the above. A more specific example (a non-exhaustive list) of the readable storage medium may comprise: an electrical connection with one or more wires, a portable disk, a hard disk, a random access memory (RAM), a read-only memory (ROM), an erasable programmable read-only memory (EPROM or flash memory), a fiber, a portable compact disk read-only memory (CD-ROM), an optical memory, a magnetic memory, or any suitable combination of the above.

The computer-readable storage medium may comprise data signals in a baseband or propagated as parts of carriers, in which readable program codes are carried. The propagated data signals may be in various forms, comprising but not limited to electromagnetic signals, optical signals or any suitable combination of the above. The readable storage medium may also be any readable medium beyond the readable storage media. The readable medium is capable of sending, propagating or transmitting a program used by or in combination with an instruction execution system, apparatus or device or a combination. The program codes contained in the readable medium may be transmitted by any appropriate medium, comprising but not limited to wireless, wired, optical cable, RF, etc., or any appropriate combination of the above.

A program code for executing operations of the present disclosure may be compiled using one or more programming languages. The programming languages comprise object-oriented programming languages, such as Java and C++, and also comprise conventional procedural programming languages, such as “C” language or similar programming languages. The program code may be completely executed on a user's computing device, partially executed on a user's device, executed as a separate software package, partially executed on a user's computing device and partially executed on a remote computing device, or completely executed on a remote computing device or server. In the circumstance involving a remote computing device, the remote computing device may be connected to a user's computing device over any type of network, comprising a local area network (LAN) or wide area network (WAN), or may be connected to an external computing device (for example, connected over the Internet using an Internet service provider).

In embodiments, a virtual image scenario can be established according to the first video data acquired by a camera of the smart phone, and then a commodity region identified by means of unit identification can be supplemented to the virtual image scenario, so that the marking of the commodity region in the virtual image scenario is achieved, thereby preventing repeated marking of the same commodity region, and improving the efficiency of marking the commodity region and generating training images. The present disclosure can be applied to a smart phone, so that commodities can be directly identified and marked in front of a shelf, thereby improving the accuracy of marking, and preventing labeling errors caused by unclear images or high commodity similarity.

Various aspects of the present disclosure may be appreciated from the following enumerated example embodiments (EEEs):

EEE1. An augmented reality-based image marking method for marking images of commodities on a shelf by using a smart phone, comprising the following steps:

step S1: acquiring first video data, converting the first video data into a plurality of temporally consecutive single-frame images, and then generating a virtual image scenario according to the plurality of single-frame images;

step S2: acquiring second video data, performing unit identification on the single-frame images to be labeled in the second video data with a preset unit identification model to identify a plurality of commodity regions, and labeling the commodity regions; and

step S3: replacing corresponding regions in the virtual image scenario with single-frame images with the labeled plurality of commodity regions.

EEE2. The augmented reality-based image marking method according to EEE1, wherein step S2 comprises the following steps:

step S201: acquiring second video data, and extracting a plurality of temporally consecutive single-frame images to be marked from the second video data;

step S202: performing unit identification on the single-frame images to be marked with the unit identification model to identify a plurality of commodity regions; and

step S203: labeling the identified commodity regions with label boxes.

EEE3. The augmented reality-based image marking method according to EEE2, wherein step S201 comprises the following steps:

step S2011: acquiring second video data, and extracting a plurality of temporally consecutive single-frame images to be marked from the second video data;

step S2012: sequentially extracting feature points of two temporally consecutive single-frame images to be marked, and calculating a displacement between the two temporally consecutive single-frame images to be marked according to the feature points; and

step S2013: determining whether the displacement is less than a preset displacement threshold, and triggering step S202 when the displacement is less than the preset displacement threshold.

EEE4. The augmented reality-based image marking method according to EEE2, further comprising the following steps after step S3:

step M1: determining in the virtual image scenario whether there are label boxes having wrong label positions, dragging, if there are label boxes having wrong label positions, the label boxes for correction, or proceeding to step M2 if there are no label boxes having wrong label positions;

step M2: selecting a commodity region to be marked and scanning a commodity corresponding to the commodity region to obtain a label code of the commodity region, or directly inputting a corresponding label code for a commodity region for marking;

step M3: selecting all commodity regions corresponding to the label code in the virtual image scenario, thus completing marking the commodities corresponding to the label code.

EEE5. The augmented reality-based image marking method according to EEE4, wherein the label boxes having wrong label positions comprise any one or more of the following errors:
part of a commodity region is outside the label box;
part of two adjacent commodity regions are inside the label box; and
the ratio of the area of the label box to the area of the commodity region is greater than a preset ratio threshold.

EEE6. The augmented reality-based image marking method according to EEE1, wherein step S1 comprises the following steps:

step S101: turning on a camera of the smart phone, and moving the smart phone to acquire first video data;

step S102: recording, when moving the smart phone, a corresponding relationship between each single-frame image in the first video data and position coordinates of the camera, wherein the position coordinates comprise spatial three-dimensional coordinates, an angle of nutation θ, an angle of precession ψ and an angle of rotation φ of the camera; and step S103: generating a virtual image scenario according to the plurality of single-frame images, and generating a corresponding relationship between the position coordinates of the camera and image regions in the virtual image scenario.

EEE7. The augmented reality-based image marking method according to EEE6, wherein step S3 comprises the following steps:

step S301: obtaining position coordinates of the camera corresponding to the single-frame images with the labeled plurality of commodity regions;

step S302: determining, according to the position coordinates of the camera, image regions in the virtual image scenario corresponding to the single-frame images with the labeled plurality of commodity regions; and

step S303: replacing the corresponding image regions in the virtual image scenario with the single-frame images with the labeled plurality of commodity regions to update the virtual image scenario.

EEE8. An augmented reality-based image marking system for implementing an augmented reality-based image marking method according to any one of EEE1 to EEE7, comprising:

a virtual image scenario construction module, configured to acquire first video data, convert the first video data into a plurality of temporally consecutive single-frame images, and then generate a virtual image scenario according to the plurality of single-frame images;

an identifying and labeling module, configured to acquire second video data, perform unit identification on the single-frame images to be labeled in the second video data with a preset unit identification model to identify a plurality of commodity regions, and label the commodity regions; and

a virtual image scenario updating module, configured to replace corresponding regions in the virtual image scenario with single-frame images with the labeled plurality of commodity regions.

EEE9. An augmented reality-based image marking device, comprising:

a processor; and

a memory storing executable instructions of the processor,

wherein the processor is configured to perform the steps of the augmented reality-based image marking method according to any one of EEE1 to EEE7 by performing the executable instructions.

EEE10. A computer-readable storage medium for storing a program, wherein the steps of the augmented reality-based image marking method according to any one of EEE1 to EEE7 are implemented when the program is executed.

A virtual image scenario can be established according to the first video data acquired by a camera of the smart phone, and then a commodity region identified by means of unit identification can be supplemented to the virtual image scenario, so that the marking of the commodity region in the virtual image scenario is achieved, thereby preventing repeated marking of the same commodity region, and improving the efficiency of marking the commodity region and generating training images. The present disclosure can be applied to a smart phone, so that commodities can be directly identified and marked in front of a shelf, thereby improving the accuracy of marking, and preventing errors caused by unclear images or high commodity similarity.

The specific embodiment of the present disclosure is described above. It should be understood that the present disclosure is not limited to the specific implementation described above, and various alterations or modifications may be made by those skilled in the art within the scope of the claims, which does not affect the essential contents of the present disclosure.

1. A method, comprising:
performing using an electronic device comprising a processor coupled to a memory and coupled to a camera;
acquiring, using the camera, first video data for commodities on a shelf;
converting the first video data into a plurality of single-frame images;
generating a virtual image scenario according to the plurality of single-frame images;
acquiring, using the camera, second video data for the commodities on the shelf;
performing unit identification on the plurality of single-frame images in the second video data with a preset unit identification model to identify a plurality of commodity regions;
labeling the identified plurality of commodity regions; and
replacing corresponding regions in the virtual image scenario with ones of the single-frame images with the labeled commodity regions.

2. The method according to claim 1, wherein converting the first video data into the plurality of single-frame images comprises:
converting the first video data into a plurality of temporally consecutive single-frame images.

3. The method according to claim 1, further comprising:
extracting a plurality of single-frame images from the second video data,
wherein labeling the identified plurality of commodity regions comprises:
labeling the identified commodity regions with label boxes.

4. The method according to claim 3, wherein extracting the plurality of single-frame images from the second video data comprises:
extracting a plurality of temporally consecutive single-frame images from the second video data,
wherein the method further comprises:
sequentially extracting feature points from two temporally consecutive single-frame images of the plurality of temporally consecutive single-frame images;
calculating a displacement corresponding to the two temporally consecutive single-frame images according to the feature points; and
determining whether the displacement is less than a preset displacement threshold.

5. The method according to claim 4, wherein performing unit identification on the plurality of single-frame images in the second video data with the preset unit identification model comprises:
selecting one from the two temporally consecutive single-frame images, in response to the displacement being less than the preset displacement threshold; and
performing unit identification on the selected single-frame image with the preset unit identification model.

6. The method according to claim 3, further comprising:
determining whether there is an error in positions of the label boxes in the virtual image scenario; and
in response to a label box having a position in error in the virtual image scenario, dragging the label box to correct the position of the label box.

7. The method according to claim 1, further comprising:
scanning a commodity corresponding to at least one of the identified plurality of commodity regions to obtain a label code of the commodity region from the scanned commodity, or
directly inputting a corresponding label code for the at least one of the identified plurality of commodity regions.

8. The method according to claim 7, further comprising:
selecting commodity regions corresponding to the label code from the virtual image scenario to complete marking commodities corresponding to the label code.

9. The method according to claim 6, wherein the error in positions of the label boxes comprises one or more errors, the errors comprising:
part of a commodity region is outside the corresponding label box;
part of an adjacent commodity region are inside the corresponding label box; and
a ratio of an area of the label box to the area of the corresponding commodity region is greater than a preset ratio threshold.

10. The method according to claim 1, wherein acquiring first video data comprises:
moving the electronic device to acquire the first video data,
wherein the method further comprises:
when moving the electronic device, recording a corresponding relationship between each single-frame image in the first video data and position coordinates of the camera, wherein the position coordinates comprise spatial three-dimensional coordinates, an angle of nutation θ, an angle of precession ψ and an angle of rotation φ of the camera,
wherein generating a virtual image scenario according to the plurality of single-frame images comprises:
generating a corresponding relationship between the position coordinates of the camera and the image regions in the virtual image scenario.

11. The method according to claim 10, wherein replacing corresponding regions in the virtual image scenario with ones of the single-frame images with the labeled commodity regions comprises:
obtaining position coordinates of the camera corresponding to the single-frame images with the labeled plurality of commodity regions;
determining, according to the position coordinates of the camera, image regions in the virtual image scenario corresponding to the single-frame images with the labeled plurality of commodity regions; and
replacing the determined image regions in the virtual image scenario with the single-frame images with the labeled plurality of commodity regions to update the virtual image scenario.

12. An electronic device, comprising:
a camera;
a processor; and
a memory comprising program instructions stored therein that, when executed by the processor, cause the processor to perform operations comprising:
acquiring, using the camera, first video data for commodities on a shelf;
converting the first video data into a plurality of single-frame images;
generating a virtual image scenario according to the plurality of single-frame images;
acquiring, using the camera, second video data for the commodities on the shelf;
performing unit identification on the plurality of single-frame images in the second video data with a preset unit identification model to identify a plurality of commodity regions;
labeling the identified plurality of commodity regions; and
replacing corresponding regions in the virtual image scenario with ones of the single-frame images with the labeled commodity regions.

13. The electronic device according to claim 12, wherein converting the first video data into the plurality of single-frame images comprises:
converting the first video data into a plurality of temporally consecutive single-frame images.

14. The electronic device according to claim 12, wherein the operations further comprise:
extracting a plurality of single-frame images from the second video data,
wherein labeling the identified plurality of commodity regions comprises:
labeling the identified commodity regions with label boxes.

15. The electronic device according to claim 14, wherein extracting the plurality of single-frame images from the second video data comprises:
extracting a plurality of temporally consecutive single-frame images from the second video data,
wherein the operations further comprise:
sequentially extracting feature points from two temporally consecutive single-frame images of the plurality of temporally consecutive single-frame images;
calculating a displacement corresponding to the two temporally consecutive single-frame images according to the feature points; and
determining whether the displacement is less than a preset displacement threshold.

16. The electronic device according to claim 15, wherein performing unit identification on the plurality of single-frame images in the second video data with the preset unit identification model comprises:
selecting one from the two temporally consecutive single-frame images, in response to the displacement being less than the preset displacement threshold; and
performing unit identification on the selected single-frame image with the preset unit identification model.

17. A computer program product comprising:
a tangible computer readable storage medium comprising computer readable program code embodied in the medium that, is executable by a processor of a computing device to cause the computing device to perform operations comprising:
acquiring first video data for commodities on a shelf;
converting the first video data into a plurality of single-frame images;
generating a virtual image scenario according to the plurality of single-frame images;
acquiring second video data for the commodities on the shelf;
performing unit identification on the plurality of single-frame images in the second video data with a preset unit identification model to identify a plurality of commodity regions;
labeling the identified plurality of commodity regions; and
replacing corresponding regions in the virtual image scenario with ones of the single-frame images with the labeled commodity regions.

18. The computer program product according to claim 17, wherein converting the first video data into the plurality of single-frame images comprises:
converting the first video data into a plurality of temporally consecutive single-frame images.

19. The computer program product according to claim 17, wherein the operations further comprise:
extracting a plurality of single-frame images from the second video data,
wherein labeling the identified plurality of commodity regions comprising:
labeling the identified commodity regions with label boxes.

20. The computer program product according to claim 19, wherein extracting the plurality of single-frame images from the second video data comprises:
extracting a plurality of temporally consecutive single-frame images from the second video data,
wherein the operations further comprise:
sequentially extracting feature points from two temporally consecutive single-frame images of the plurality of temporally consecutive single-frame images;
calculating a displacement corresponding to the two temporally consecutive single-frame images according to the feature points; and
determining whether the displacement is less than a preset displacement threshold.
